(19) United States
(12) Patent Application Publication
(10) Pub. No.: US 2026/0040410 A1
(43) Pub. Date: Feb. 5, 2026

(54) HEATER PLATE, HEATER DEVICE COMPRISING A HEATER PLATE AND METHOD OF MANUFACTURING A HEATER PLATE

(71) Applicant: Nederlandse Organisatie voor toegepast-natuurwetenschappelijk onderzoek TNO, 's-Gravenhage (NL)

(72) Inventor: Rob Jacob HENDRIKS, Waalre (NL)

(21) Appl. No.: 19/099,913

(22) PCT Filed: Aug. 4, 2023
(86) PCT No.: PCT/NL2023/050417

§ 371 Date: Jan. 30, 2025

(30) Foreign Application Priority Data
Aug. 4, 2022 (EP) 22188806.8

(51) Int. Cl. H05B 3/26

(52) U.S. Cl. CPC H05B 3/262; H05B 2203/005; H05B 2203/011

(57) ABSTRACT

An improved heater plate is provided herewith that comprises a carrier plate having a first main side and a second main side opposite the first main side. The carrier plate is provided at the first main side with a resistive heating layer and is provided with a plurality of busbars that are accommodated in respective V-shaped grooves in the carrier plate at the second main side. The V-shaped grooves taper inward in the direction of the first main side towards respective slit-shaped openings, and the busbars are electrically connected with the resistive heating layer through the respective slit-shaped openings. Also a method of manufacturing the improved heater plate is provided as well as a heater device comprising the heater plate.

### BACKGROUND The present invention pertains to a heater plate.

The present invention further pertains to a heater device comprising a heater plate.

The present invention still further pertains to a method of manufacturing a heater plate.

International patent application WO2021230746 discloses a transfer method to transfer a viscous functional material onto a receiving substrate. The method provides a plate with a plurality of individually addressable resistive heater elements. In use, a viscous functional material is heated with the resistive heater elements so a vapor pressure is induced at an interface of the functional material and the plate. Therewith a transfer of viscous functional material from the plate to a target surface is induced. There is a need to provide a heater plate that can be manufactured efficiently and to provide a method for efficiently manufacturing a heater plate.

### SUMMARY

It is a first object of the invention to provide an improved heater plate that can be manufactured efficiently.

It is a second object of the invention to provide a heater device comprising the improved heater plate.

It is a third object of the invention to provide an improved method with which a heater plate can be manufactured efficiently.

The improved heater plate in accordance with the first object comprises a carrier plate having a first main side and a second main side opposite said first main side. The carrier plate is provided at the first main side with a resistive heating layer. At its second main side a plurality of V-shaped grooves is formed in the carrier plate and respective busbars are accommodated in these grooves. The V-shaped grooves taper inward in the direction of the first main side towards respective slit-shaped openings, and the busbars therein are electrically connected with the resistive heating layer through the respective slit-shaped openings.

The improved heater plate can be obtained with an improved manufacturing method. Therein the carrier plate is provided of a material having an anisotropic etching behavior, such as silicon. The carrier plate has a first main surface at a first main side thereof and has a second main surface at a second main side opposite to the first main side.

The method comprises etching a plurality of V-shaped grooves at the second main surface of the carrier plate, which V-shaped grooves taper inward in a direction of the a first main side. Due to the anisotropic etching behavior of the material of the carrier plate the V-shaped grooves can be formed with a well defined wall angle in a simple etching process. For example by using KOH or

TMAH etchants, 1-0-0 oriented silicon is etched along the crystal structure, leaving a wall angle of 54.74 degrees.

The V-shaped grooves to be formed extend towards respective slit-shaped openings in the first main surface.

The method further comprises depositing a resistive heater layer at the first main surface and depositing respective busbars in the V-shaped grooves. Therewith respective electrical connections are provided with the resistive heater layer via the respective slit-shaped openings in the first main surface.

In an embodiment the slit shaped openings in the first main surface can be formed as part of the process of etching the V-shaped grooves. In that case the etching process is continued until the etchant has fully protruded the carrier plate. In practice it may be the case that the carrier plate has a varying thickness. In that case the slit-shaped openings that are formed in the first main surface also have a varying width. I.e. at locations where the carrier plate is relatively thick the slit formed with this process is relatively narrow as compared to locations where the carrier plate is relatively thin. Accordingly, an example of this method comprises an additional step before the process of etching the V-shaped grooves. In this additional step a thickness profile of the carrier plate is measured and an etch mask is provided on the second main surface that has respective rectangular openings for the plurality of V-shaped grooves to be formed, such that the respective rectangular openings each have a proper width that is proportional to the thickness of the carrier plate where the respective V-shaped grooves are to be formed. Therewith it is achieved that the grooves formed by the etching process end in slits with the same width. It is noted that if the thickness of the carrier plate varies in the length direction of the grooves to be formed, then the width of the openings may accordingly vary in a manner proportional to the thickness of the carrier plate in the length direction.

In another embodiment of the method the slit-shaped openings in the first main surface are formed in a separate process. This embodiment comprises providing the respective slit-shaped openings in the first main surface by anisotropic etching slit-shaped grooves in the first main surface of the carrier plate. In this embodiment the plurality of V-shaped grooves is etched up to a depth less than a minimum value of the thickness of the carrier plate. In this alternative embodiment it is not necessary to know the exact thickness of the plate locally. If it is known that the plate varies in thickness between a minimum value Dmin and a maximum value Dmax, the V-shaped grooves can be etched with a same depth Dg not exceeding the minimum value and the slit-shaped grooves can be etched with a depth that is at least equal to the difference between the maximum value Dmax and the depth Dg. Also in this case the respective electrical connections with the resistive heater layer extend via the respective slit-shaped grooves to the respective busbars in the V-shaped grooves. It is noted that these processes of etching the V-shaped grooves and etching the slit shaped openings could be performed in arbitrary order. It is however preferred to first etch the V-shaped grooves, and then use reactive ion etching afterwards to etch slits from the other side. It's preferred to etch the slits anisotropic, so the slit width remains more narrow.

In an embodiment the plurality of busbars are provided as respective busbar layers conformal to a surface of the respective V-shaped grooves. Therewith an electrical contact between the busbars and an power source can be established in an efficient manner, for example using pogo pins. In examples a busbar layer is provided with an interface sublayer of a metal with a low thermal expansion coefficient at a side facing the carrier plate. The interface sub-layer serves as an interface between the material of the carrier plate and a core of the busbar. Therewith a highly conductive metal, such as copper, can be used for the core, without being restricted too much by requirements of a thermal expansion coefficient. Specifically in such examples the resistive heating layer is also formed of said metal with a low thermal expansion coefficient and a portion of the interface sublayer protrudes through the respective slit-shaped openings. By using the same metal with a low thermal expansion coefficient both for the interface layer and the resistive heating layer the manufacturing process is simplified.

In embodiments the busbar layer comprises a contact sublayer of a metal with a low contact resistance at a side facing away from the carrier plate. With only a thin sublayer of a low contact resistance type metal, the electrical contact between the busbar and a power supply is substantially improved.

In some embodiments the resistive heater layer of the heater plate is patterned into a plurality of mutually insulated resistive heater strips that extend into a further lateral direction of the plate transverse to the lateral direction of the busbars and one or more of the busbars are interrupted at positions opposite positions between mutually subsequent ones of the heater strips. With the interruptions in the busbars mutually insulated busbar portions are formed. The resistive heater layer can be controlled pixel-wise by supplying a drive voltage to a pair of busbar portions in contact with a section of a heater strip or to a continuous busbar and a busbar portion in contact with a heater strip section.

In other embodiments the resistive heater layer of the heater plate is patterned into a plurality of mutually insulated resistive heater segments and one or more of the busbars are interrupted at positions opposite positions at a boundary between mutually subsequent ones of the heater strips. With the interruptions in the busbars mutually insulated busbar portions are formed. The resistive heater layer can be controlled segment-wise by supplying a drive voltage to a pair of busbar portions in contact with a resistive layer segment or to a continuous busbar and a busbar portion in contact with a resistive heater layer segment.

An improved resolution with which heat induction in the heater plate can be controlled is achieved with an embodiment comprising a plurality of longitudinal busbar portions that are mutually insulated from each other. The plurality of longitudinal busbar portions comprises the following:
a) respective sets of first longitudinal busbar portions formed in respective ones of a first plurality of first busbars of a first polarity extending in a first lateral direction;
b) respective sets of second longitudinal busbar portions in respective ones of a second plurality of busbars of the first polarity extending in a second lateral direction (y) transverse to the first lateral direction, which second busbar portions each extend at a central position between a respective busbar portion of mutually subsequent ones of the first plurality of first busbars;
c) respective sets of third longitudinal busbar portions formed in respective ones of a third plurality of third busbars of a second polarity opposite to the first polarity, wherein respective third busbars extend in the first lateral direction between mutually subsequent ones of the first plurality of first busbars, and wherein a respective set of third longitudinal busbar portions comprises respective pairs of third longitudinal busbar portions of at least substantially the same length, which have a respective first end near respective ones of mutually second longitudinal busbar portions of mutually subsequent second busbars, and which have respective second ends facing each other; and
d) respective sets of fourth longitudinal busbar portions formed in respective ones of a fourth plurality of fourth busbars of the second polarity, wherein respective fourth busbars extend in the second lateral direction between mutually subsequent ones of the second plurality of second busbars, and wherein a respective set of fourth longitudinal busbar portions comprises respective pairs of fourth longitudinal busbar portions of at least substantially the same length, which have a respective first end near respective ones of mutually first longitudinal busbar portions of mutually subsequent first busbars, and which have respective second ends facing each other.

In this embodiment with an improved resolution the resistive heater layer comprises respective resistive heater layer segments between respective pairs of first longitudinal busbar portion and an immediately neighboring third longitudinal busbar portion and a respective pairs of second longitudinal busbar portion and an immediately neighboring fourth longitudinal busbar portion. In operation a respective resistive heater layer segment can be selectively heated by supplying an electric power to a respective pair of contact pins.

Typically a heater plate is provided as a component of a heater device in a printer. The heater device comprising in addition to the heater plate also a support unit for supporting the heater plate at its second main side. The support unit (comprises respective spring loaded contact pins, also denoted as pogo pins, to provide an electrical contact with respective ones of the busbar. It is attractive if the support unit of the heater device is suitable for combination with various types of heater plates used by various customers, such as a standard heater plate which is configured to print a large area at once or to print on a line wise basis, heater plate suitable for pixel-wise printing and a high resolution heater plate that enable printing at a four times higher resolution. In view of these considerations a further improved embodiment of the heater plate is constituted in that it comprises a plurality of longitudinal busbar portions that are mutually insulated from each other, the plurality of longitudinal busbar portions comprising:
a) respective sets of first longitudinal busbar portions formed in respective ones of a first plurality of first busbars of a first polarity extending in a first lateral direction;
b) respective sets of second longitudinal busbar portions formed in respective ones of a second plurality of second busbars of the first polarity extending in a first lateral direction, extending in a second lateral direction transverse to the first lateral direction, wherein each quadruple formed by pair of mutually subsequent first busbars and a pair of mutually subsequent second busbars defines a respective area bounded by a respective pair of busbar portions of each of the first busbars of a first busbar pair and a pair of mutually subsequent second busbars of each second busbar pair;
c) a respective cross shaped busbar being arranged in each area which partitions the each area into four quadrants, wherein each quadrant comprises a respective lateral portion of the resistive heating layer, which is electrically connected to a respective branch of the cross shaped busbar and a busbar portion of a respective one of the busbars that define the boundary of the area.

In this further improved embodiment of the heater plate a first one of a pair of longitudinal busbar portions of a first busbar has an end between two subsequent busbar portions of a first one of the pair of second busbars that bounds the area and a second one of the pair of longitudinal busbar portions of a first busbar has an end between a branch of the cross shaped busbar facing the first busbar and a branch of a cross shaped busbar in a directly neighboring area facing said busbar. This improved heater plate also provides for a four times higher resolution, but in addition, it can be combined with a support unit that is also compatible with the standard line wise addressable heater plate and pixel wise addressable heater plate.

### BRIEF DESCRIPTION OF THE DRAWINGS

These and other aspects are disclosed in more detail with reference to the drawings. Therein:

FIG. 1 schematically shows a heater device that comprises an embodiment of a heater plate as claimed herein and a support unit;

FIG. 2 shows a portion of the embodiment of the heater plate of FIG. 1 in more detail;

FIG. 3A to 3L shows steps of an embodiment of an improved method of manufacturing the improved heater plate;

FIG. 4A to 4C shows steps of another embodiment of the improved method of manufacturing the improved heater plate;

FIG. 5A to 5C depict exemplary of a method wherein an improved heater plate is used for depositing a viscous substance on a target surface;

FIG. 6A and 6B depict a first further embodiment of the improved heater plate;

FIG. 7A and 7B depict a second further embodiment of the improved heater plate;

FIG. 8A and 8B depict a third further embodiment of the improved heater plate;

FIG. 9A and 9B depict a fourth further embodiment of the improved heater plate;

FIG. 10A and 10B depict a fifth further embodiment of the improved heater plate.

### DETAILED DESCRIPTION OF THE DRAWINGS

Like reference symbols in the various drawings indicate like elements unless otherwise indicated.

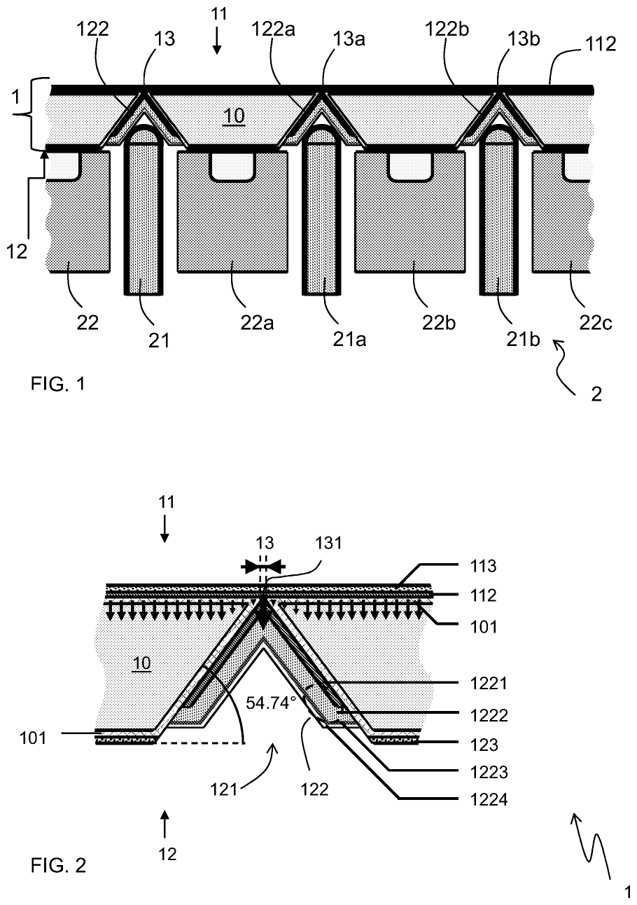

FIG. 1 schematically shows a heater device that comprises a heater plate 1 and a support unit 2 for supporting the heater plate 1. As shown in FIG. 1, the heater plate 1 comprises a carrier plate 10 that has a first main side 11 and a second main side 12 opposite to the first main side. The carrier plate 10 is provided at the first main side 11 with a resistive heating layer 112. At the second main side 12 it is provided with a plurality of busbars 122, 122a, 122b, that are accommodated in respective V-shaped grooves 121, 121a, 121b in the carrier plate 10. The V-shaped grooves 121, 121a, 121b . . . taper inward in the direction of the first main side 11 towards respective slit-shaped openings 13, 13a, 13b and the busbars 122 are electrically connected with the resistive heating layer 112 through their proper slit-shaped openings 13. The support unit 2 that supports the, second main side 12 of, the heater plate 1 comprises spring loaded contact pins 21, 21a, 21b to provide an electrical contact with respective ones of the busbars 122, 122a, 122b. In the example shown, the support unit 2 comprises additional support elements 22, 22a, 22b, 22c, . . . that do not serve to provide an electrical contact.

In operation a viscous functional material, e.g. a solder, a curable electrically conductive ink or a curable electrically insulating ink is provided on the surface of the heater plate 1 at its first main side 11 and the heater plate 1 provided with the viscous functional material is arranged opposite a target surface. In this arrangement one or more sections of the heater plate 1 are heated by supplying an electrical power between pairs of contact pins. Therewith the viscous functional material is heated with the resistive heater layer 112 so that a vapor pressure is induced at an interface of the functional material and the plate. The vapor pressure induces a transfer of viscous functional material from the plate 1 to the target surface. In an embodiment the additional support elements 22, 22a, 22b, 22c are of a thermally well conductive material so as to enable a rapid cooling down of the heater plate 1 subsequent to this operation.

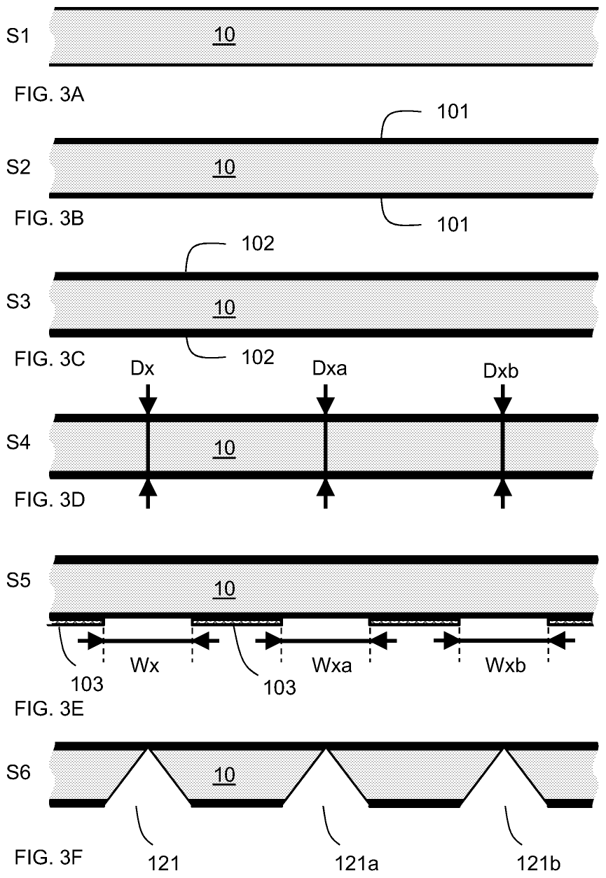

FIG. 2 shows a portion of an embodiment of the heater plate 1 in more detail. As shown in FIG. 2, the resistive heater layer 112 extends in a continuous manner at the first main side 11 of the carrier plate 10. In the embodiment shown the resistive heater layer 112 is coated with an insulating layer 113. Therewith the heater plate 1 is also suitable for printing electrically conductive functional materials. As shown in FIG. 1 and in detail in FIG. 2 for the busbar 122, the plurality of busbars is provided as respective busbar layers conformal to the surface of the V-shaped grooves 121 wherein they are formed. As shown in FIG. 2 therewith a reliable electrical contact between the busbars 122, 122a, 122b and the pogo pins 21, 21a, 21b can be established in an efficient manner.

As shown in more detail in FIG. 2, for the busbar layer 122 an interface sublayer 1221 of a metal with a low thermal expansion coefficient is provided at a side of the busbar layers facing the carrier plate 10. The interface sub-layer 1221 serves as an interface between the material of the carrier plate 10 and a core 1222 of the busbar. Therewith a highly conductive metal such as copper can be used for the core, without being restricted too much by requirements of a thermal expansion coefficient. Suitable for this purpose are metals with a CTE below 10 ppm/K, and preferably 5 ppm/K or lower. Metals like W, Mo, Cr, Ta are examples thereof. Also alloys are suitable, for example W90Ti10 which has 10% titanium for improved adhesion. In the example shown also the resistive heating layer 112 is formed of the same low CTE metal, e.g. Mo as used for the interface sublayer 1221 of the busbar 122. The electrical interconnection 131 between the busbar 122 and the resistive heating layer 112 is also formed with the same low CTE metal. This facilitates the manufacturing process as in that case the electrical interconnection 131 between the busbar 122 and the resistive heating layer 112 is formed as part of depositing the interface sublayer 1221.

In the example shown in FIG. 2, a busbar layer 122 also comprises a contact sublayer 1224 of a metal with a low contact resistance at a side facing away from the carrier plate 10. With only a thin sublayer 1224 of a low contact resistance type metal, like Au, the electrical contact between the busbar and a power supply is substantially improved. Other metals suitable for this purpose are platinum, silver and other noble metals.

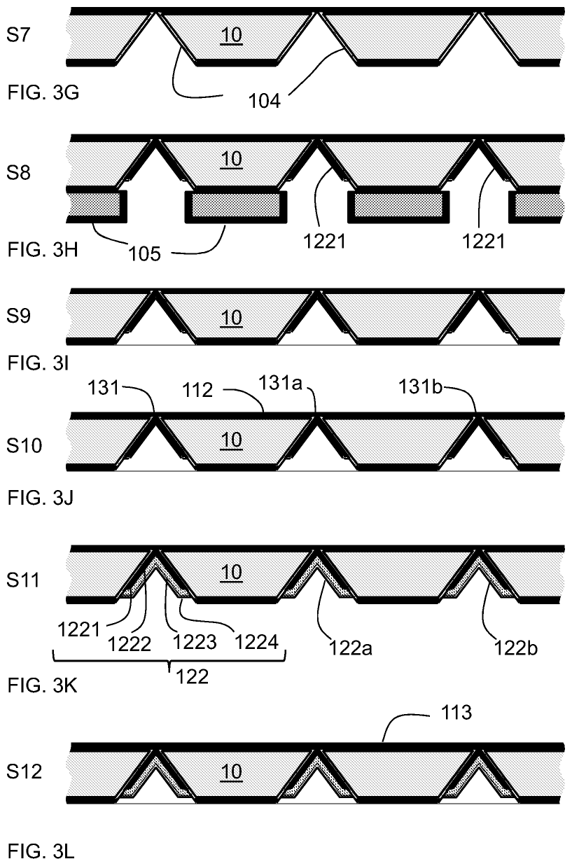

FIG. 3A-3L shows an embodiment of a method of manufacturing a heater plate 1. As shown in FIG. 3A, a carrier plate 10 is provided in a step S1 of a material having an anisotropic etching behavior. An example thereof is 1-0-0 oriented silicon plate, which may have a thickness in a range between about 30 micron and about 1000 micron. The carrier plate 10 has a first main surface at a first main side 11 thereof and having a second main surface at a second main side 12 thereof.

As shown in FIG. 3F, in a step S6 a plurality of V-shaped grooves 121, 121a, 121b, . . . is etched at the second main surface of the carrier plate 10. The V-shaped grooves taper inward in a direction towards the first main surface. Due to the anisotropic etching behavior of the carrier plate 10, this can be simply achieved in a wet etching process with an etchant like KOH or TMAH,

As shown in FIG. 3L, in a step S12 a resistive heater layer 112 is deposited at the first main surface. The resistive heater layer 112 is preferably of a low CTE metal as referred to above.

Also respective busbars 122, 122a, 122b . . . are deposited in the V-shaped grooves 121, 121a, 121b, . . . to therewith providing respective electrical connections 131 with the resistive heater layer 112 via respective slit-shaped openings 13, 13a, 13b, in the first main surface. As shown in FIG. 3H and 3K, this process can be performed in a plurality of steps. In this example an aligned sputter mask 105 is used in a step S8 to subsequently deposit a low CTE metal sublayer 1221, like Mo and a seed layer, e.g. Cu, for a sublayer 1222 that forms the core of the busbars 122, 122a, 122b. Then in a subsequent step S11, the sublayer 1222 is deposited on the seed layer by electroplating, in this case followed by electroplating an intermediate layer 1223 and a sublayer 1224 of a metal with a low contact resistance, such as Au. The intermediate layer 1223, in this case of Ni facilitates the adherence of the low contact resistance layer 1224.

In an example the low CTE metal sublayer 1221, like Mo has a thickness of about 1500 nm, the sublayer 1222 of Cu, which forms the core of the busbar 122 has a thickness of about 20 micron, the intermediate sublayer 1223 of Ni has a thickness of about 3 micron and the low contact resistance sublayer 1224 of Au has a thickness of about 500 nm. Alternatively it could be contemplated to provide the busbars entirely of a low CTE metal. In that case the busbars would however have less superior electrical properties.

In the embodiment of the method shown in FIG. 3A to 3L the step S6 of etching the V-shaped grooves is preceded by the step S3 to S5 as shown in FIG. 3C to 3E respectively. In step S3 an etch mask layer 102, such as silicon nitride (Si3N4) is deposited on the main surfaces of the carrier plate. In step S4 a thickness profile of the carrier plate 10 is measured and in subsequent step S5 an etch mask 103 is provided by photolithographically processing the etch mask layer on the second main surface so that respective substantially rectangular openings for the plurality of V-shaped grooves 121, 121a, 121b, . . . are formed. The rectangular openings have a proper width that is proportional to the thickness of the carrier plate 10 where the respective V-shaped grooves 121, 121a, 121b, . . . are to be formed. For example if the thickness of the carrier plate 10 measured at the locations of the V-shaped grooves 121, 121a, 121b to be formed is Dx, Dxa and Dxb, then the width Wx, Wxa, Wxb of the openings at these locations is c.Dx+d, c.Dxa+d and c.Dxb+d. Therein c is a constant (2/tg α) which is determined by the anisotropic characteristics of the material of the carrier plate 10, and d is the desired width of the slit to be formed at the first main surface. For example, if the carrier plate is a 1-0-0 silicon wafer, then the grooves formed as a result of the etching process taper inward with an angle of 54.74°. With these steps it is achieved that the grooves formed by the etching process end in slits having the same width despite thickness variations of the carrier plate. In this example it is presumed that the thickness of the carrier plate only varies in the direction from left to right in the drawing. In practice also thickness variations may occur in the direction orthogonal thereto. In that case the openings in the etch mask 103 are not exactly rectangular but have a width that varies according to the variations in depth in that orthogonal direction. Accordingly, the width Wx(x,y) of a opening in the etch mask 103 is equal to c.Dx(x,y)+d, wherein (x,y) is the position on the second main surface. In an optional step S2, an electrical insulator layer is provided at the surface of the carrier plate 10 after the carrier plate 10 has been provided S1 before performing further steps. Optionally also an electrical insulator layer is provided S7 subsequent to etching S6, S6A the plurality of V-shaped grooves. These steps S2, S7 are advantageous if the carrier plate 10 is not a good electrical insulator. Preferably the electrical insulator layer has a low thermal conductivity. These optional step S2, S7, as shown in FIG. 3B and FIG. 3G are preferably performed by thermally oxidizing the carrier plate 10. The thermal oxidization efficiently provides an electrically insulating layer 101, 104 with a low thermal conductivity.

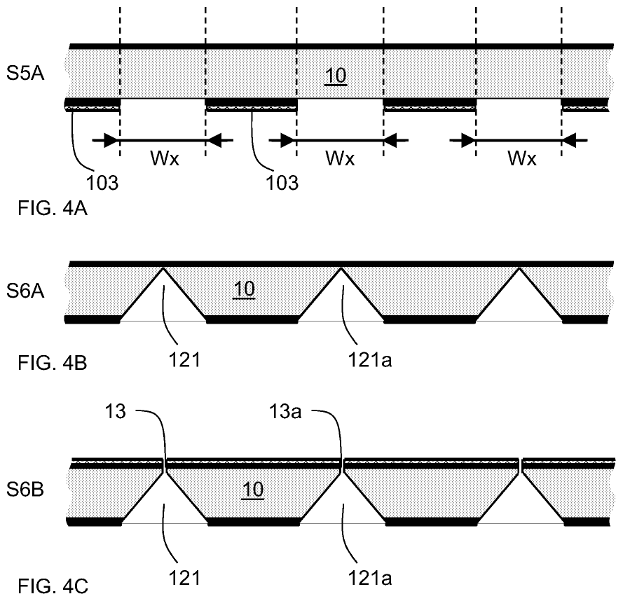

FIG. 4A, 4B, 4C illustrate aspects of another approach, wherein slits with a uniform width can be obtained without needing a thickness profile measurement S4 as described with reference to FIG. 3D. It is sufficient that it is known between which boundaries the thickness varies. Also, it is not necessary that the width of the openings in the etch mask 103 is determined very accurately as a function of the position on the carrier plate 10 with a step S5 as shown in FIG. 3E. As in the previously described approach, a plate 10 is provided with steps S1 and S3 described in FIG. 3A and 3C, optionally with the intermediate step S2.

In this case it suffices that the edge mask 103 as formed in the etch mask layer 102 in the step S5A has rectangular openings of uniform width Wx. As in step S6 shown in FIG. 3F, this alternative approach comprises a step S6A of etching the plurality of V-shaped grooves 121, 121a, 121b, . . . with an etchant like KOH or TMAH. However contrary to step S6 of FIG. 3F, the grooves are etched with a depth less than a thickness of the carrier plate 10. In a separate step S6B shown in FIG. 4C the slit-shaped openings 13, 13a, 13b, in the first main surface are formed by anisotropic etching the first main surface of the carrier plate 10, for example with a reactive ion etching process. In the example shown the slit shaped openings 13, 13a, . . . are etched in a step S6B succeeding the step S6A of etching the V-shaped grooves 121, 121a, . . . . Whereas a reversal of these steps is also possible, best results are obtained with the order as shown in FIG. 4B, 4C. If it is known that the plate varies in thickness between a minimum value Dmin and a maximum value Dmax, the V-shaped grooves can be etched with a same depth Dg not exceeding the minimum value and the slit-shaped grooves can be etched with a depth that is at least equal to the difference between the maximum value Dmax and the depth Dg. Hence, due to the fact that the separate step S6B results in a slit of predetermined width for the electric connection between a busbar and the resistive heating layer 112 regardless thickness variations in the plate 10, it is not necessary that the pattern in the etch mask has width variations that closely corresponds to the thickness variations of the plate. The open areas in the etch mask may have substantially the same shape. Minor variations in the width of the open areas will not affect the width of the slits.

The steps S5, S6A, S6B as described here can be succeeded with the step S12 of depositing the resistive heating layer 112 as described with reference to FIG. 3L and depositing the busbars in one or more steps.

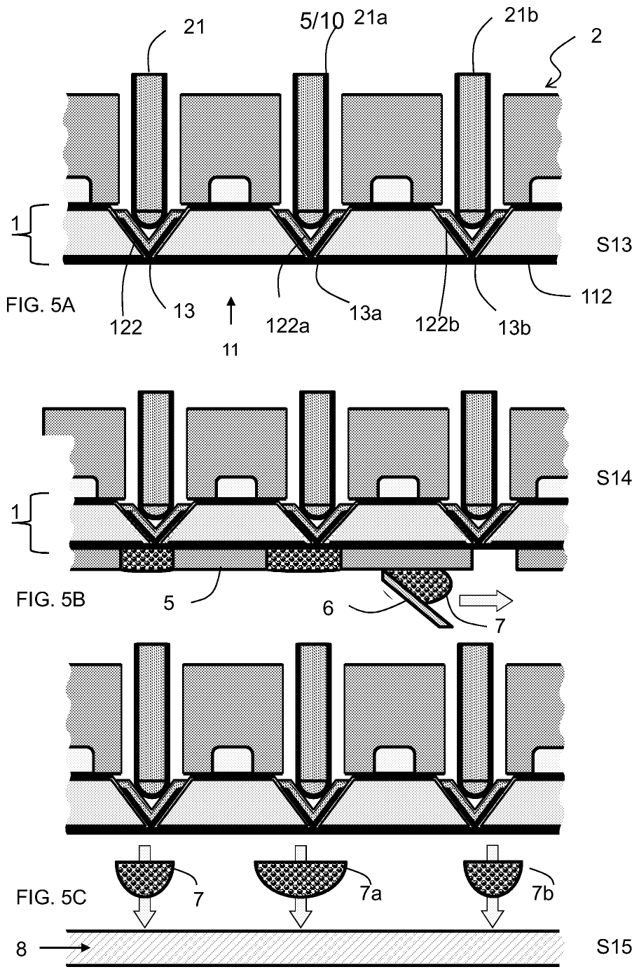

FIG. 5A, 5B, 5C shows subsequent steps S13, S14, S15. In step S13, shown in FIG. 5A, the heater plate 1 obtained with the first approach or the second approach, or variants thereof is combined with a support unit 2 to form a heater device. The support unit 2 comprises respective spring loaded contact pins 21 to provide an electrical contact with respective ones of the busbar. In step S14, shown in FIG. 5B, a patterned layer of a viscous substance 7, such as a curable electrically conductive ink is provided at the first main side 11 of the heater plate 1, for example by stencil/screen printing using a print mask 5 and a doctor blade or squeegee 6. In step S15, shown in FIG. 5C, an electric power is provided to the resistive heater layer 112 via the contact-pins 21 of the support unit therewith the surface of the resistive heater layer 112 is resistively heated, therewith inducing a heat flux in a range of about 50 to about 500 kW/cm² and a fluence of about 0.2 to about 2 J/cm². Therewith the viscous substance 7, 7a, 7b is transferred to a surface of a target.

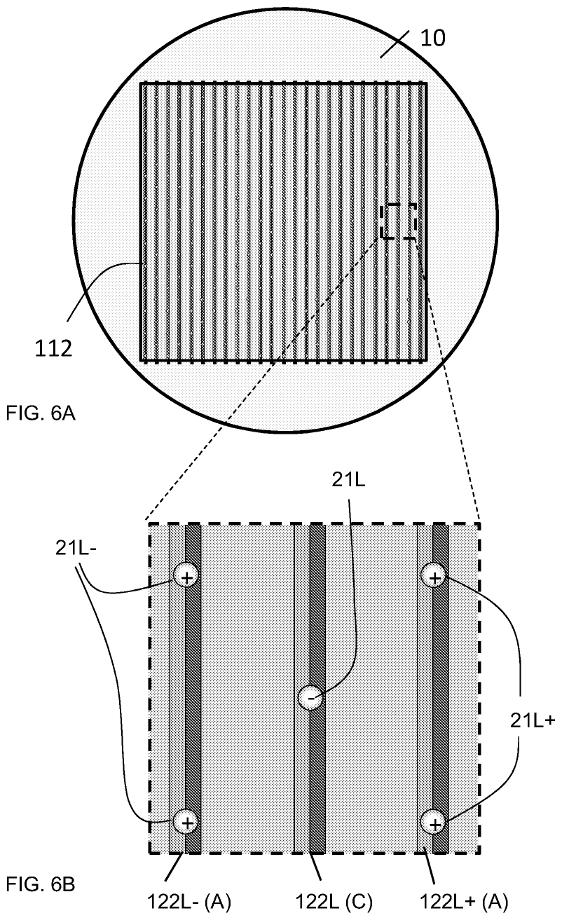

FIG. 6A, FIG. 6B shows aspects of a first embodiment of a heater plate 1 in more detail. FIG. 6A shows a bottom view of the heater plate, i.e. a view of the second main side 12. FIG. 6B shows a section thereof in more detail. In this embodiment the busbars extend over the full size of the plate. Line shaped sections of the plate can be heated independent from each other. For example a line shaped section can be separately heated by supplying a power between busbar 122L-with contact pins 21L-and busbar 122L with contact pins 21L. Another line shaped section can be separately heated by supplying a power between busbar 122L with contact pins 21L and busbar 122L+ with contact pins 21L+.

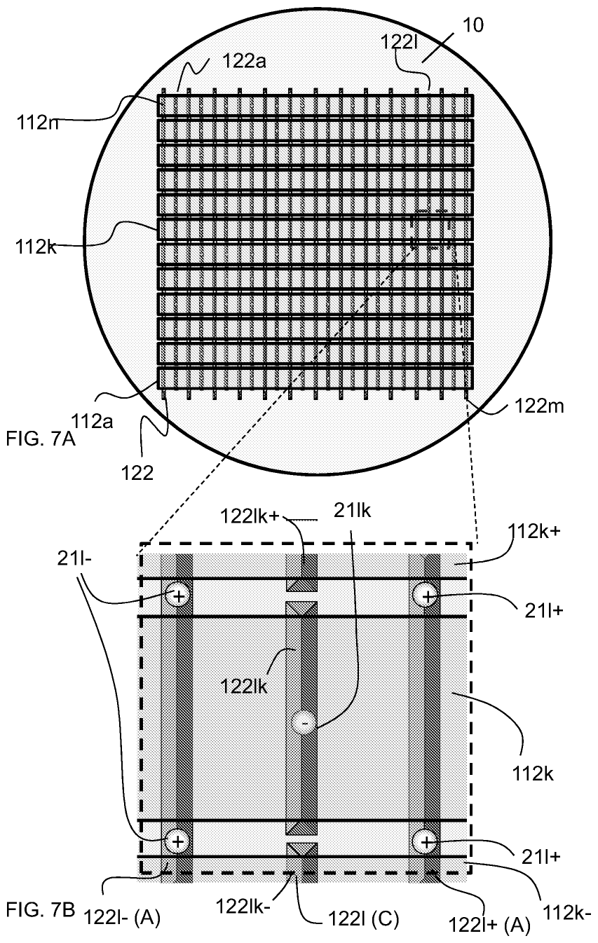

FIG. 7A, 7B shows aspects of a second embodiment of a heater plate 1 also in bottom view, wherein FIG. 7B shows a section of the heater plate in more detail. In this example, the resistive heater layer 112 is patterned into a plurality of mutually insulated resistive heater strips 112a, 112k, , 112n that extend into a further lateral direction of the plate transverse to the lateral direction of the busbars 122, 122a, 1221, , 122m. Also, the busbars are interrupted at positions opposite positions between mutually subsequent ones of the heater strips. With the interruptions in the busbars mutually insulated busbar portions 122lk−, 122lk, 122lk+ are formed. In this embodiment the resistive heater layer can be controlled pixel-wise by supplying a drive voltage to a pair of busbar portions in contact with a section of a heater strip or to a continuous busbar and a busbar portion in contact with a heater strip section.

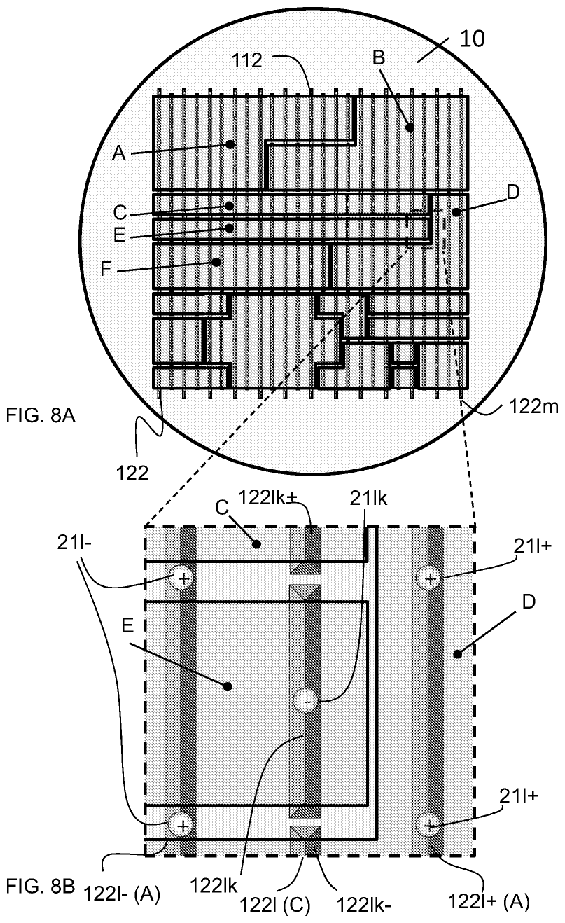

FIG. 8A, 8B show again another embodiment also in bottom view, wherein FIG. 8B shows a section of the heater plate in more detail. In this embodiment of the heater plate 1 the resistive heater layer 112 is patterned into a plurality of mutually insulated resistive heater segments A, B, C, D, E, F, and one or more of the busbars are interrupted at positions opposite positions at a boundary between mutually subsequent ones of the heater strips. With the interruptions in the busbars mutually insulated busbar portions 122lk−, 122lk, 122lk+ are formed. The resistive heater layer 112 can be controlled segment-wise by supplying a drive voltage to a pair of busbar portions in contact with a resistive layer segment or to a continuous busbar and a busbar portion in contact with a resistive heater layer segment.

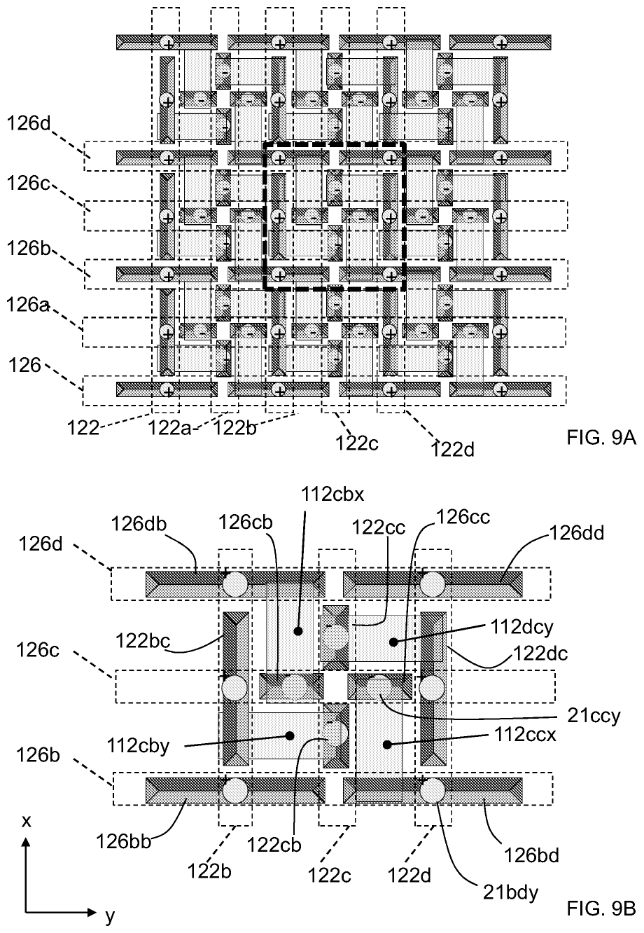

FIG. 9A, 9B show a still further embodiment also in bottom view. FIG. 9A shows a portion of the heater plate and FIG. 9B shows a detail thereof. This embodiment of the heater plate comprises a plurality of longitudinal busbar portions that are mutually insulated from each other. These include respective sets of first, second, third and fourth longitudinal busbar portions as specified in more detail below.

The respective sets of first longitudinal busbar portions 122bc, 122dc are formed in respective ones of a first plurality of first busbars 122, 122b, 122d, of a first polarity that extend in a first lateral direction (x).

The respective sets of second longitudinal busbar portions 126bb, 126bd, , 126db, 126dd are formed in respective ones of a second plurality of busbars 126, 126b, 126d, also of the first polarity that extend in a second lateral direction (y) transverse to the first lateral direction. The second busbar portions each extend at a central position between a respective busbar portion of mutually subsequent ones of the first plurality of first busbars.

The respective sets of third longitudinal busbar portions 122cb, 122cc are formed in respective ones of a third plurality of third busbars 122a, 122c, of a second polarity opposite to the first polarity. The third busbars extend in the first lateral direction (x) between mutually subsequent ones of the first plurality of first busbars, and a respective set of third longitudinal busbar portions comprises respective pairs of third longitudinal busbar portions of at least substantially the same length, which have a respective first end near respective ones of mutually second longitudinal busbar portions of mutually subsequent second busbars, and which have respective second ends facing each other.

The respective sets of fourth longitudinal busbar portions 126cb, 126cc are formed in respective ones of a fourth plurality of fourth busbars 126a, 126c, of the second polarity. The fourth busbars extend in the second lateral direction between mutually subsequent ones of the second plurality of second busbars, and a respective set of fourth longitudinal busbar portions comprises respective pairs of fourth longitudinal busbar portions of at least substantially the same length, which have a respective first end near respective ones of mutually first longitudinal busbar portions of mutually subsequent first busbars, and which have respective second ends facing each other.

The resistive heater layer comprises respective resistive heater layer segments 112cbx, 112cby, 112ccx, 112dcy between respective pairs of a first longitudinal busbar portions and an immediately neighboring third longitudinal busbar portion and respective pairs of a second longitudinal busbar portion and an immediately neighboring fourth longitudinal busbar portion.

In operation respective resistive heater layer segments 112cbx, 112cby, 112ccx, 112dcy can be selectively heated by supplying an electric power to a respective pair of contact pins. For example, the heater layer segment 112ccx can be heated resistively by providing an electric power to the pair of contact pins 21ccy and 21bdy.

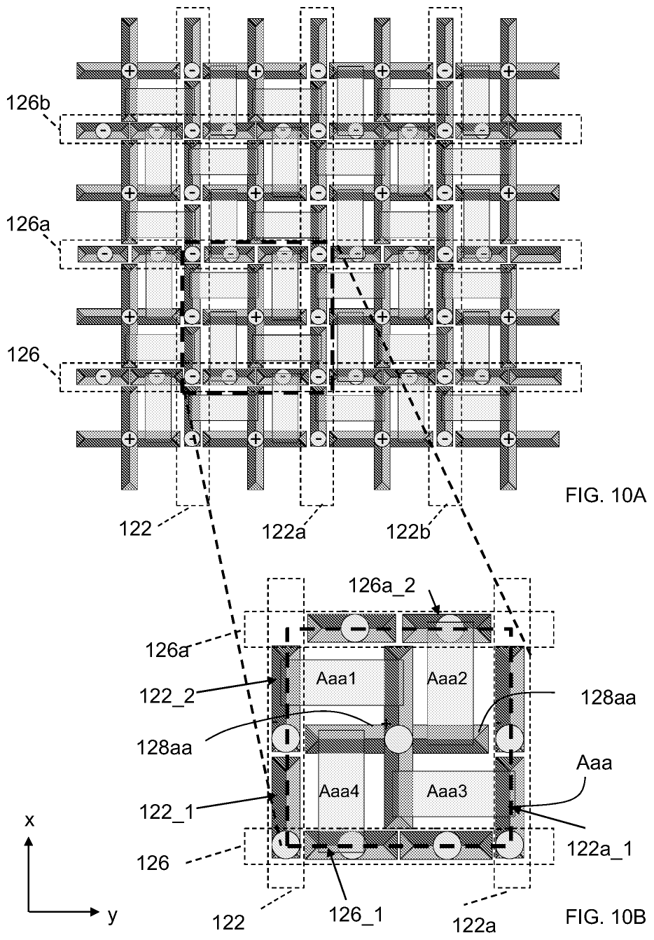

FIG. 10A, 10B show a still further embodiment also in bottom view. FIG. 10A shows a portion of the heater plate and FIG. 10B shows a detail thereof.

The embodiment of the heater plate 1 as shown in FIG. 10A, 10B comprises a plurality of longitudinal busbar portions that are mutually insulated from each other. These include respective sets of first longitudinal busbar portions and respective sets of second longitudinal busbar portions.

The respective sets of first longitudinal busbar portions are formed in respective ones of a first plurality of first busbars 122, 122a, 122b, of a first polarity that extend in a first lateral direction (x).

The respective sets of second longitudinal busbar portions are formed in respective ones of a second plurality of second busbars 126, 126a, 126b, also of the first polarity that extend in a second lateral direction (y) transverse to the first lateral direction (x).

Each quadruple formed by a first busbar pair of mutually subsequent first busbars and a second busbar pair of mutually subsequent second busbars defines a respective area Aaa bounded by a respective pair of mutually subsequent busbar portions of each of the first busbars of the first busbar pair 122, 122a and a respective pair of mutually subsequent second busbar portions of each of the second busbars of the second busbar pair 126, 126a.

The heater plate further comprises a respective cross shaped busbar 128aa of the second polarity opposite to the first polarity arranged in each area which partitions the each area into four quadrants Aaa1, Aaa2, Aaa3, Aaa4.

Each quadrant comprises a respective lateral portion of the resistive heating layer that is electrically connected to a respective branch of the cross shaped busbar and a busbar portion 122_2, 126a_2, 122a_1, 126_1 of a respective one of the busbars 122, 126a, 122a, 126 that define the boundary of the area Aaa.

A first one 122_1 of a pair of longitudinal busbar portions 122_1, 122_2 of a first busbar 122 has an end between two subsequent busbar portions of a first one 126 of the pair of second busbars that bounds the area. A second one 122_2 of the pair of longitudinal busbar portions 122_1, 122_2 of a first busbar 122 has an end between a branch of the cross shaped busbar 128aa facing the first busbar 122 and a branch of a cross shaped busbar in a directly neighboring area facing said busbar.

As in the embodiment of FIG. 9A, 9B, the improved heater plate of FIG. 10A, 10B provides for a four times higher resolution, but in addition, it can be combined with a support unit that is also compatible with the standard line wise addressable heater plate and pixel wise addressable heater plate.

In the claims the word “comprising” does not exclude other elements or steps, and the indefinite article “a” or “an” does not exclude a plurality. A single component or other unit may fulfill the functions of several items recited in the claims. The mere fact that certain measures are recited in mutually different claims does not indicate that a combination of these measures cannot be used to advantage. Any reference signs in the claims should not be construed as limiting the scope.

1. A heater plate comprising:
a carrier plate having a first main side and a second main side opposite the first main side,
wherein the carrier plate is provided at the first main side with a resistive heating layer and being is provided with a plurality of busbars that are accommodated in respective V-shaped grooves in the carrier plate at the second main side,
wherein ones of the V-shaped grooves taper inward in a direction of the first main side towards respective slit-shaped openings, and
wherein the busbars are electrically connected with the resistive heating layer through the respective slit-shaped openings.

2. The heater plate according to claim 1, wherein the plurality of busbars are provided as respective busbar layers conformal to a surface of the respective V-shaped grooves.

3. The heater plate according to claim 2, wherein a busbar layer at a side facing the carrier plate comprises an interface sublayer of a metal having a low thermal expansion coefficient.

4. The heater plate according to claim 3, wherein the resistive heating layer is also formed of the metal having a low thermal expansion coefficient, and
wherein a portion of the interface sublayer protrudes through the respective slit-shaped openings.

5. The heater plate according to claim 1, wherein a busbar layer at a side facing away from the carrier plate comprises a contact sublayer of a metal having a low contact resistance.

6. The heater plate according to claim 1, wherein the resistive heater layer is patterned into a plurality of mutually insulated resistive heater strips that extend into a further lateral direction of the plate that is transverse to the lateral direction of the busbars, and
wherein one or more of the busbars are interrupted at positions opposite positions between mutually subsequent ones of the mutually insulated heater strips.

7. The heater plate according to claim 1, wherein the resistive heater layer is patterned into a plurality of mutually insulated resistive heater segments, and
wherein one or more of the busbars are interrupted at positions opposite positions at a boundary between mutually subsequent ones of the mutually insulated heater strips.

8. The heater plate according to claim 1, comprising a plurality of longitudinal busbar portions that are mutually insulated from each other, wherein the plurality of longitudinal busbar portions comprise:
respective sets of first longitudinal busbar portions formed in respective ones of a first plurality of first busbars of a first polarity extending in a first lateral direction,
respective sets of second longitudinal busbar portions in respective ones of a second plurality of busbars of the first polarity extending in a second lateral direction transverse to the first lateral direction, wherein the second busbar portions each extend at a central position between a respective busbar portion of mutually subsequent ones of the first plurality of first busbars;
respective sets of third longitudinal busbar portions formed in respective ones of a third plurality of third busbars of a second polarity, wherein respective third busbars extend in the first lateral direction between mutually subsequent ones of the first plurality of first busbars, and wherein a respective set of third longitudinal busbar portions comprises respective pairs of third longitudinal busbar portions of at least substantially the same length, which have a respective first end near respective ones of mutually second longitudinal busbar portions of mutually subsequent second busbars, and which have respective second ends facing each other,
respective sets of fourth longitudinal busbar portions formed in respective ones of a fourth plurality of fourth busbars of the second polarity, wherein respective fourth busbars extend in the second lateral direction between mutually subsequent ones of the second plurality of second busbars, and wherein a respective set of fourth longitudinal busbar portions comprises respective pairs of fourth longitudinal busbar portions of at least substantially the same length, which have a respective first end near respective ones of mutually first longitudinal busbar portions of mutually subsequent first busbars, and which have respective second ends facing each other, and
wherein the resistive heater layer comprises respective resistive heater layer segments-between respective pairs of a first longitudinal busbar portion and an immediately neighboring third longitudinal busbar portion and respective pairs of a second longitudinal busbar portion and an immediately neighboring fourth longitudinal busbar portion.

9. The heater plate according to claim 1, comprising a plurality of longitudinal busbar portions that are mutually insulated from each other, wherein the plurality of longitudinal busbar portions comprise:
respective sets of first longitudinal busbar portions formed in respective ones of a first plurality of first busbars of a first polarity extending in a first lateral direction,
respective sets of second longitudinal busbar portions formed in respective ones of a second plurality of second busbars of the first polarity extending in a second lateral direction transverse to the first lateral direction, wherein each quadruple formed by a first busbar pair of mutually subsequent first busbars and a second busbar pair of mutually subsequent second busbars defines a respective area bounded by a respective pair of mutually subsequent busbar portions of each of the first busbars of the first busbar pair and a respective pair of mutually subsequent second busbar portions of each of the second busbars of the second busbar pair;
a respective cross shaped busbar being arranged in each area which partitions the each area into four quadrants,
wherein each quadrant comprises a respective lateral portion of the resistive heating layer, which is electrically connected to a respective branch of the cross shaped busbar and a busbar portion, of a respective one of the busbars that define the boundary of the area;
wherein a first one of a pair of longitudinal busbar portions of a first busbar has an end between two subsequent busbar portions of a first one of the pair of second busbars that bounds the area, and
wherein a second one of the pair of longitudinal busbar portions of a first busbar has an end between a branch of the cross shaped busbar facing the first busbar and a branch of a cross shaped busbar in a directly neighboring area facing the busbar.

10. A heater device comprising:
the heater plate according to claim 1 and
a support unit for supporting the heater plate at the second main side,
wherein the support unit comprises respective spring loaded contact pins to provide an electrical contact with respective ones of the busbar.

11. A method of manufacturing a heater plate, the method comprising:
providing a carrier plate of a material having an anisotropic etching behavior, the carrier plate having a first main surface at a first main side thereof and having a second main surface at a second main side thereof;
etching a plurality of V-shaped grooves at the second main surface of the carrier plate, wherein ones of the V-shaped grooves taper inward in a direction of the a first main side towards the first main surface;
depositing a resistive heater layer at the first main surface; and
depositing respective busbars in the V-shaped grooves therewith providing respective electrical connections with the resistive heater layer via the respective slit-shaped openings in the first main surface.

12. The method according to claim 11, further comprising, before-the etching:
measuring a thickness profile of the carrier plate; and
providing on the second main surface an etch mask having respective rectangular openings for the plurality of V-shaped grooves to be formed,
wherein the respective rectangular openings each have a proper width that is proportional to the thickness profile of the carrier plate where the respective V-shaped grooves are to be formed.

13. The method according to claim 11 comprising, providing the respective slit-shaped openings in the first main surface by anisotropic etching slit-shaped grooves in the first main surface of the carrier plate-and etching the plurality of V-shaped grooves with a depth less than a thickness of the carrier plate,
wherein the respective electrical connections with the resistive heater layer extend via the respective slit-shaped grooves to the respective busbars in the V-shaped grooves

14. The method of claim 11, wherein the plurality of busbars are deposited as respective busbar layers conformal to a surface of the respective V-shaped grooves.

15. The method according to claim 11, wherein an electrical insulator layer is provided at the surface of the carrier plate both:
after the carrier plate has been provided before performing further steps; and
subsequent to etching the plurality of V-shaped grooves.

16. The heater plate according to claim 2, wherein a busbar layer at a side facing away from the carrier plate comprises a contact sublayer of a metal having a low contact resistance.

17. A heater device comprising:
a heater plate according to claim 6, and
a support unit for supporting the heater plate at the second main side,
wherein the support unit comprises respective spring loaded contact pins to provide an electrical contact with respective ones of the busbar.

18. A heater device comprising:
a heater plate according to claim 7, and
a support unit for supporting the heater plate at the second main side,
wherein the support unit comprises respective spring loaded contact pins to provide an electrical contact with respective ones of the busbar.

19. A heater device comprising:
a heater plate according to claim 8, and
a support unit for supporting the heater plate at the second main side, wherein the support unit comprises respective spring loaded contact pins to provide an electrical contact with respective ones of the busbar.

20. A heater device comprising:
a heater plate according to claim 9, and
a support unit for supporting the heater plate at the second main side,
wherein the support unit comprises respective spring loaded contact pins to provide an electrical contact with respective ones of the busbar.
